(19) United States
(12) Patent Application Publication
(10) Pub. No.: US 2024/0405306 A1
(43) Pub. Date: Dec. 5, 2024

(54) METHOD FOR RECYCLING WASTE FROM THE MANUFACTURING OF LITHIUM-ION ACCUMULATORS

(71) Applicant: Volkswagen Aktiengesellschaft, Wolfsburg (DE)

(72) Inventors: Karina AMBROCK, Lehre (DE); Miriam KUNZE, Seelze (DE); Philipp TEICHERT, Lehre (DE); Jessica Maria HUESKER, Braunschweig (DE)

(73) Assignee: Volkswagen Aktiengesellschaft, Wolfsburg (DE)

(21) Appl. No.: 18/731,931

(22) Filed: Jun. 3, 2024

(30) Foreign Application Priority Data
Jun. 2, 2023 (DE) 10 2023 205 153.2

(51) Int. Cl. H01M 10/54; B09B 3/40; B09B 101/16

(52) U.S. Cl. CPC H01M 10/54; B09B 3/40; B09B 2101/16

(57) ABSTRACT

A method for recycling waste that arises during the manufacturing of electrodes for lithium-ion accumulators, material strips being produced during the manufacturing, each material strip including a foil made from a metallic material, which is coated with an electrode active material. Pieces of the material strips accumulating as waste during the manufacturing and being collected separately for recycling. Each piece including a foil piece, on which electrode active material is applied, and, for the purpose of recycling, the pieces are subjected to a thermal treatment to detach the electrode active material from the foil sections.

This nonprovisional application claims priority under 35 U.S.C. § 119(a) to German Patent Application No. 10 2023 205 153.2, which was filed in Germany on Jun. 2, 2023, and which is herein incorporated by reference.

### BACKGROUND OF THE INVENTION

### Field of the Invention

The invention relates to a method for recycling waste that arises during the manufacturing of electrodes for lithium-ion accumulators.

### Description of the Background Art

Lithium-ion accumulators are currently in common use. They are employed, among other things, in motor vehicles, where they are used, for example, as so-called traction batteries, i.e., as energy stores for supplying electrical prime movers.

Depending on the application, a lithium-ion accumulator includes one or multiple accumulator cells, and each accumulator cell usually has a positive electrode, a negative electrode, a separator, and an electrolyte as essential components. With respect to the precise structure, a multiplicity of designs are known.

The manufacturing of lithium-ion accumulators is delineated, for example, in “Heimes, Heiner Hans; Kampker, Achim; Lienemann, Christoph; Locke, Marc; Offermanns, Christian; Michaelis, Sarah; Rahimzei, Ehsan (2018): Produktionsprozess einer Lithium-Ionen-Batteriezelle (Production Process of a Lithium-Ion Battery Cell), Frankfurt am Main, PEM of RWTH Aachen and VDMA Eigendruck.”

### SUMMARY OF THE INVENTION

It is therefore an object of the invention is to provide a method for recycling waste from the manufacturing of lithium-ion accumulators.

The method according to the invention is used to recycle waste that arises during the manufacturing of electrodes for lithium-ion accumulators. The method is therefore a recycling method.

Methods for manufacturing electrodes for lithium-ion accumulators, i.e., manufacturing methods, are known in principle. Material strips are first manufactured, and electrodes are then separated from these material strips by means of separation processes, also referred to as slitting. A manufacturing method of this type is delineated, for example, in “Heimes, Heiner Hans; Kampker, Achim; Lienemann, Christoph; Locke, Marc; Offermanns, Christian; Michaelis, Sarah; Rahimzei, Ehsan (2018): Produktionsprozess einer Lithium-Ionen-Batteriezelle (Production Process of a Lithium-Ion Battery Cell), Frankfurt am Main, PEM of RWTH Aachen and VDMA Eigendruck.”

During the manufacturing of the electrodes, waste also arises, which comprises pieces of the material strips, namely waste pieces. A corresponding material strip is a strip material which includes a foil made from a metallic material, i.e., for example, a copper foil or an aluminum foil. The foil is coated on at least one side with an active material, namely a so-called electrode active material. Each of the aforementioned waste pieces then has a foil piece, on which electrode active material is applied.

These waste pieces, or pieces for short, are collected separately over the course of the recycling method. In other words, the pieces are collected separately from other waste, so that the waste is present more or less as waste of a single type. Within the meaning of this application, the waste is thus formed by the pieces and possibly by foil pieces without electrode active material and/or electrode active material without foil pieces.

The waste collected in this manner is finally subjected to a thermal treatment over the course of the recycling method, with the aid of which, in the case of the waste pieces, the electrode active material is detached from the foil pieces.

In the case of the aforementioned pieces, i.e., the waste pieces which arise as waste during the manufacturing of the electrodes, three types may typically be differentiated, namely a strip type, a section type, and a cutting type. Depending on the application, the recycling method is applied to waste pieces of only one type, to waste pieces of two types, in particular the strip type and the section type, or to waste pieces of all three types.

If the recycling method is applied to waste pieces of at least two types, according to at least one example of the method, the collection and the thermal treatment of the pieces also take place separately according to type. In particular, a variant is preferred, in which waste pieces of the cutting type are collected and thermally treated separately from the other waste pieces.

A piece of the strip type is an entire piece of material strip, i.e., an entire material strip, which was rejected, for example, because the coating made from electrode active material does not meet the quality standards. A piece of this type typically has a length of more than 100 meters and, in particular, more than 1,000 meters.

A piece of the section type is, for example, a section of a material strip, which was separated from the material strip, for example, because the coating made from electrode active material in this section does not meet the quality standards or because the foil is cracked. The section type also typically includes sections of a material strip which are described as so-called startup or departure material. A piece of this type typically has a length of more than 5 meters and, in particular, more than 20 meters.

A piece of the cutting type is a piece of material strip, which is left over as a cutting during one of the aforementioned separation processes, i.e., slitting.

Regardless of which type of waste pieces is recycled with the aid of the recycling method or which types of waste pieces are recycled with the aid of the recycling method, a thermal treatment takes place over the course of carrying out the recycling method, with the aid of which, in the case of the waste pieces, the electrode active material is removed from the foil pieces. This has already been explained above.

The recycling method is preferably applied to waste pieces, in which the metallic material of the foil pieces and the electrode active material have different thermal expansion properties, in particular, different coefficients of longitudinal expansion. In this case, the different thermal expansion properties, i.e., in particular, the different coefficients of longitudinal expansion, are utilized to detach the electrode active material from the foil pieces.

The recycling method is also preferably applied to waste pieces, in which the metallic material of the foil pieces has a coefficient of longitudinal expansion α₁, and the electrode active material has a coefficient of longitudinal expansion α₂, and in which α₁=f*α₂ or α₂=f*α₁ applies, at least at room temperature, the factor f being greater than or equal to 1.2 and, in particular, greater than or equal to 1.5.

A thermal treatment of the waste pieces can further take place in such a way that the latter are heated from a room temperature to a thermal treatment temperature T_{w}. Waste heat generated during the manufacturing of the electrodes, i.e., over the course of the manufacturing method, is preferably used for heating. Regardless thereof, thermal treatment temperature T_{w} is typically in the range from 100° C. to 300° C. and, in particular, in the range from 200° C. to 300° C.

In some cases, it is also expedient if the thermal treatment is carried out under special environmental conditions, and the waste pieces are not exposed to the ambient air in these cases. Instead, the thermal treatment then takes place, for example, in a protective gas atmosphere or under vacuum conditions.

Depending on the application, the waste pieces are furthermore heated from a room temperature to thermal treatment temperature T_{w} and held at thermal treatment temperature T_{w} for period of time t, for example for a period of time t greater than or equal to 2 minutes, greater than or equal to 5 minutes, greater than or equal to 10 minutes, or for a period of time t greater than or equal to 20 minutes.

The heating to thermal treatment temperature T_{w} can take place at a heating rate of less than or equal to 1° C./s or less than or equal to 0.5° C./s.

The thermal treatment can take place in that nitrogen liquid at a room temperature can be applied to the waste pieces.

It is furthermore advantageous if, over the course of carrying out the recycling method, the electrode active material is separated from the foil sections with the aid of at least one gas flow, i.e., for example an air jet.

A carrying out of the recycling method is also expedient in which the electrode material is separated from the foil sections, in that it is brushed off or daubed off.

In particular, when the recycling method is applied to waste pieces of the strip type and/or the section type, it is furthermore advantageous if the thermal treatment of each waste piece takes place in a roll-to-toll process, for which the corresponding waste piece is then previously clamped.

A foil can then be recovered from the metallic material in this way, i.e., an uncoated foil, which is preferably subsequently reused to manufacture electrodes, in that it is again coated with electrode active material.

If the recycling method is applied to waste pieces of the cutting type, a variant is expedient, in which the waste pieces are reduced to small pieces, in particular shredded, prior to the thermal treatment. In this case as well, it is furthermore advantageous if, over the course of further carrying out the recycling method, the electrode active material is separated from the foil sections with the aid of at least one gas flow, i.e., for example an air jet.

Regardless thereof, the detached and separated electrode active material is ground up in a further step of the recycling method in at least some applications. The electrode active material is typically mixed with a solvent and ground up in the solvent.

The ground-up electrode active material can be used as a component for an electrode active material suspension in a further step of the recycling method. This electrode active material suspension is then, in turn, used to manufacture electrodes.

The foil pieces freed of the electrode active material by the thermal treatment of the waste pieces are expediently also further recycled. The foil pieces of the strip type are preferably supplied to another coating process. In addition, this also preferably applies to the foil pieces of the section type, which are typically previously assembled into larger pieces in an intermediate processing step, for example with the aid of a so-called splicing technique. Foil pieces of the cutting type and foil pieces of the other types which may not be reused directly are typically supplied to a metal recycling process.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a side view of a first station for recycling waste that arises during the manufacturing of electrodes for lithium-ion accumulators; and

FIG. 2 shows a side view of a second station for recycling waste that arises during the manufacturing of lithium-ion accumulators.

### DETAILED DESCRIPTION

A method is described below as an example that is used to recycle waste that arises during the manufacturing of electrodes for lithium-ion accumulators. This waste comprises pieces 2 of material strips, namely waste pieces.

A corresponding material strip is a strip material which includes a foil made from a metallic material 4, i.e., for example, a copper foil or an aluminum foil. The foil is coated on at least one side with an active material, namely a so-called electrode active material 6. Each of the aforementioned waste pieces, or pieces 2 for short, then has a foil piece, on which electrode active material 6 is applied.

The pieces are now collected separately over the course of the method. In other words, pieces 2 are collected separately from other waste, so that the waste is present more or less as waste of a single type. The waste collected in this manner is then subjected to a thermal treatment, with the aid of which, in the case of pieces 2, electrode active material 6 is detached from metallic material 4.

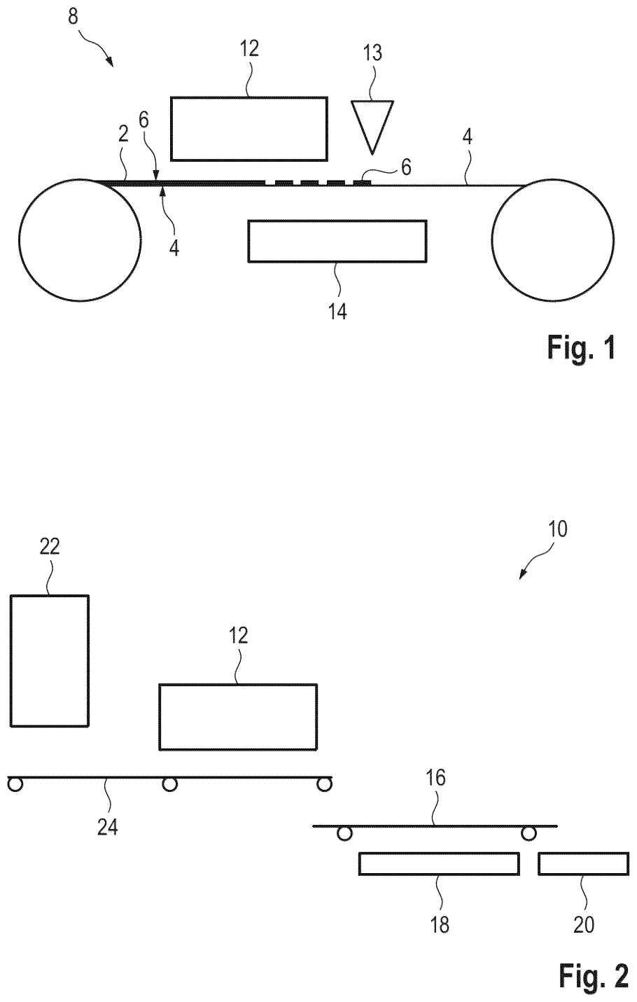

Three types of pieces 2 may be differentiated in the example, namely a strip type, a section type, and a cutting type. Pieces 2 of the strip type and the section type are collected and supplied to a first station 8 for the thermal treatment, which is indicated in FIG. 1. Pieces 2 of the cutting type are collected separately from the other pieces 2 and supplied to a second station 10 for the thermal treatment, which is sketched in FIG. 2.

A piece 2 of the strip type is an entire piece 2 of material strip, i.e., an entire material strip, which was rejected, for example, because the coating made from electrode active material 6 does not meet the quality standards. A piece 2 of this type typically has a length of more than 100 meters and, in particular, more than 1,000 meters.

A piece 2 of the section type is, for example, a section of a material strip, which was separated from the material strip, for example, because the coating made from electrode active material 6 in this section does not meet the quality standards or because the foil is cracked. The section type also typically includes sections of a material strip which are described as so-called startup or departure material. A piece 2 of this type typically has a length of more than 5 meters and, in particular, more than 20 meters.

A piece 2 of the cutting type is a piece 2 of material strip which is left over as a cutting.

As already indicated above, all pieces 2 are thermally treated over the course of carrying out the method. The thermal treatment is used to detach electrode active material 6 from metallic material 4. The different coefficients of longitudinal expansion of electrode active material 6 and metallic material 4 are utilized.

In the example, the thermal treatment of pieces 2 takes place in such a way that the latter are heated from a room temperature to a thermal treatment temperature T_{w}. Each of stations 8, 10 thus includes a heating unit 12. Thermal treatment temperature T_{w} is typically in the range from 100° C. to 300° C. and, in particular, in the range from 200 ° C. to 300° C.

The separation of electrode active material 6 and metallic material 4 then further takes place after the detachment. In the case of first station 8, a gas flow is used for this purpose, for example an air jet. First station 8 therefore includes a blower 13, with the aid of which electrode active material 6 is conveyed to a collecting container 14.

In the case of second station 10, however, a shaking unit 16 is used for separation, which is a combination of a shaking screen and a conveyor belt. Electrode active material 6 then ends up in a first collecting container 18 and metallic material 4 in a second collecting container 20.

In addition, the thermal treatment of pieces 2 of the strip type and the section type takes place in a roll-to-roll process, for which each of the corresponding pieces is clamped ahead of time. This is indicated in FIG. 1. A foil is then recovered from metallic material 4 in this way, i.e., an uncoated foil, which is preferably subsequently reused to manufacture electrodes, in that it is again coated with electrode active material 6.

The thermal treatment of pieces 2 of the cutting type does not take place in a roll-to-roll process. Instead, pieces 2 are reduced to small pieces prior to the thermal treatment. Second station 10 includes a shredder 18 for this purpose. The waste reduced to small pieces in shredder 18 then drops onto a conveyor belt 24 and is thermally treated with the aid of heating unit 12 while sitting on conveyor belt 24 before dropping onto shaking unit 16.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for recycling waste that arises during the manufacturing of electrodes for lithium-ion accumulators, wherein material strips are produced during manufacturing, and at least one of the material strips includes a foil made from a metallic material that is coated with an electrode active material, the method comprising:
collecting separately for recycling, pieces of the material strips that arise as waste during the manufacturing, each collected piece including a foil piece, on which electrode active material is applied; and
subjecting the pieces to a thermal treatment for recycling to detach the electrode active material from the foil sections.

2. The method according to claim 1, wherein the metallic material and the electrode active material have different thermal expansion properties, and wherein the thermal treatment takes place such that the different thermal expansion properties are used for detachment.

3. The method according to claim 1, wherein the pieces are heated from a room temperature to a thermal treatment temperature over the course of the thermal treatment.

4. The method according to claim 1, wherein nitrogen which is liquid at a room temperature is applied to the pieces for the thermal treatment.

5. The method according to claim 1, wherein the electrode active material is separated from the foil pieces with the aid of a gas flow for the purpose of recycling.

6. The method according to claim 1, wherein the electrode active material is brushed off the foil pieces for the purpose of recycling.

7. The method according to claim 1, wherein the thermal treatment takes place in a roll-to-roll process, for which the pieces are clamped.

8. The method according to claim 1, wherein the detached electrode active material is ground up for the purpose of recycling.

9. The method according to claim 1, wherein the detached electrode active material is ground up in a solvent for the purpose of recycling.

10. The method according to claim 8, wherein the ground-up electrode active material is used as a component for an electrode active material suspension for the purpose of recycling.
